(19) United States
(12) Patent Application Publication
(10) Pub. No.: US 2025/0257015 A1
(43) Pub. Date: Aug. 14, 2025

(54) WASTE DISPOSAL METHOD AND COMPOSTER

(71) Applicant: Vego Garden Inc., Tomball, TX (US)

(72) Inventors: GUANG-YUAN XIONG, Tomball, TX (US); LI XIANG, Shenzhen (CN); YA-XIONG WEN, Zhongshan (CN)

(21) Appl. No.: 18/633,407

(22) Filed: Apr. 11, 2024

(30) Foreign Application Priority Data
Feb. 6, 2024 (CN) 202410172873.4

(51) Int. Cl. C05F 9/04; B09B 3/60; B09B 101/70; C05F 9/02; C05F 17/60; C05F 17/70; C05F 17/907; C05F 17/993

(52) U.S. Cl. CPC C05F 9/04; B09B 3/60; C05F 9/02; C05F 17/60; C05F 17/70; C05F 17/907; C05F 17/993; B09B 2101/70

(57) ABSTRACT

The present application provides a waste disposal method that is applied to a composter including a storage cavity. The waste disposal method includes performing a first composting operation in response that first kitchen waste has been added into the storage cavity. Once the first composting operation is stopped, an internal environment of the storage cavity is adjusted to meet a composting condition of the first kitchen waste by performing an environment adjustment operation on the storage cavity according to a first time interval.

### FIELD

The present application relates to the field of equipment control, and in particular to a waste disposal method, a composter and a storage medium.

### BACKGROUND

Kitchen waste refers to waste generated by residents' daily life and activities such as a food processing, a catering service, and a canteen catering. The waste includes discarded vegetable leaves, leftovers, leftover rice, peels, eggshells, tea residues, bones, etc. Kitchen waste includes a high organic content and is easily degraded by microorganisms. Therefore, use of microorganisms for a resource disposal is one of current research hotspots. At present, the kitchen waste can be composted through a composter, and the kitchen waste can be turned from waste into fertilizer that can be used, such that it realizes the resource disposal of the kitchen waste, and achieves a purpose of saving energy and reducing emissions.

However, in related technologies, the composter is not convenient to use. For example, after the composter completes a single composting operation of kitchen waste, a user needs to take out the kitchen waste from the composter in time. If the user does not take out the kitchen waste in time, it is difficult to completely ferment the kitchen waste after one single composting operation. The kitchen waste in the composter is in a semi-closed environment, and organic matter in kitchen waste that has not been completely degraded may produce mildew, odors, etc.

### BRIEF DESCRIPTION OF THE DRAWINGS

FIG. 1 is a schematic diagram of a composter provided by one embodiment of the present application.

FIG. 2 is a schematic diagram of a composter including a cavity cover provided by one embodiment of the present application.

FIG. 3 is a flow chart of a waste disposal method provided by one embodiment of the present application.

FIG. 4 is a schematic diagram of an application scenario of a hall sensor provided by one embodiment of the present application.

FIG. 5 is a schematic structural diagram of the composter provided by the embodiment of the present application.

### DESCRIPTION

To facilitate understanding, some descriptions of concepts related to the embodiments of the present application are exemplarily provided for reference.

It should be noted that “at least one” in the present application refers to one or more, and “a plurality of” refers to two or more than two. “And/or” describes the association of associated objects, indicating that there can be three relationships. For example, A and/or B can mean: A exists alone, A and B exist simultaneously, and B exists alone, where A, B can be singular or plural. The terms “first”, “second”, “third”, “fourth”, etc. (if present) in the description, claims and drawings of the present application are used to distinguish similar objects, rather than to describe a specific order or a sequence.

A composter is used to compost kitchen waste through microorganisms, turning kitchen waste from waste into fertilizer that can be used, realizing the resource disposal of kitchen waste. However, the current composter is not convenient enough to use. Since the current composter stops working after completing a composting of kitchen waste, at this time, the composter is in a semi-sealed state, and the user must manually process the compost. If the compost is not processed, the kitchen waste in the environment of the semi-sealed state is easy to produce mildew, and odors occur.

In order to solve the technical problem that the composter is not convenient enough to use and the user needs to take out the waste in time from the composter after each composting of kitchen waste, the present application provides a waste deposal method, a composter and a storage medium, which can perform a first composting operation when it is detected that first kitchen waste has been added into a storage cavity of the composter, so that a first composting of the first kitchen waste is completed. The first kitchen waste may include kitchen waste added into the storage cavity once or multiple times during a time period between there is no kitchen waste in the storage cavity and a next composting operation; when it is detected that the first composting operation stops, i.e., it is determined that the composting of the first kitchen waste is completed, adjust an environment of the storage cavity by performing an adjustment operation on the environment of the storage cavity according to a first time interval, so that the adjusted environment meets a condition of the composting of the first kitchen waste, so that the first kitchen waste can continue to be composted, avoiding a rotting of the first kitchen waste due to failure to take it out in time after the first composting is completed, which improves the convenience of processing the kitchen waste and the use of the composter.

In order to better understand the waste disposal method, the composter and the storage medium provided by the embodiment of the present application, the waste disposal method of the present application will be described below in conjunction with the accompanying drawings.

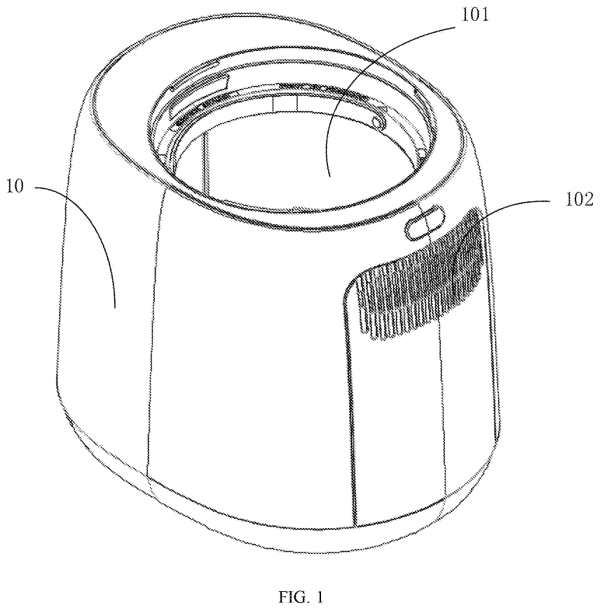

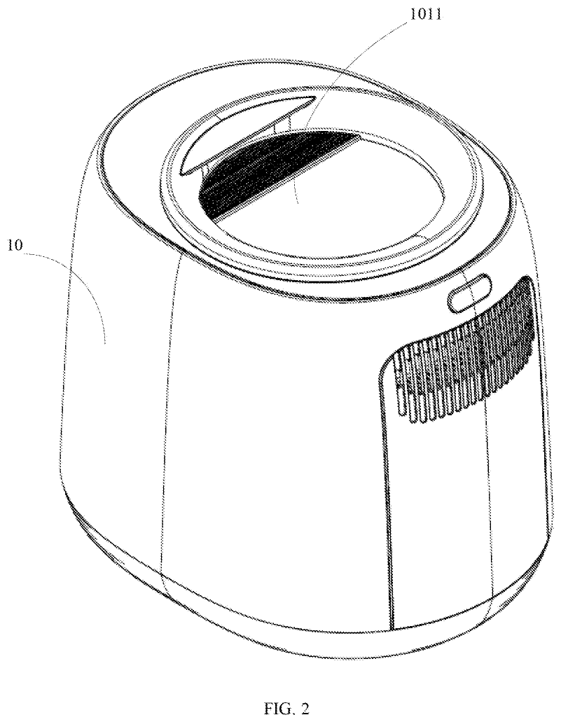

FIG. 1 is a schematic diagram of a composter provided by one embodiment of the present application. FIG. 2 is a schematic diagram of a composter including a cavity cover provided by one embodiment of the present application. As shown in FIG. 1 and FIG. 2, the composter 10 includes a storage cavity 101 and a cavity cover 1011 of the storage cavity 101. The storage cavity 101 is used to store kitchen waste and perform composting operations on the kitchen waste, so that the kitchen waste can be converted into fertilizer. The cavity cover 1011 is used to cover the storage cavity 101, so as to reduce a contact between the kitchen waste in the storage cavity 101 and an external environment, thereby better forming an environment suitable for a fermentation of the kitchen waste. The cavity cover 1011 currently shown in FIG. 2 covers the storage cavity 101. A type of the cavity cover 1011 may be one of a flip-top type, a sliding type, and a rotating type. In the embodiment of the present application, there is no restriction on the type of the cavity cover 1011.

The composter 10 also includes a processing module which is not shown in FIG. 1. The processing module may include a stirring device, a motor, a fan and a heating device. The stirring device is used to cut and/or turn the kitchen waste in the storage cavity 101, so that the kitchen waste is easier to decompose. The stirring device may include a stirring blade. The motor is used to drive the stirring device. The motor changes a rotational direction of the motor to change a cutting direction and/or a turning direction of the stirring device. For example, if the motor rotates forward, the cutting direction and/or the turning direction of the stirring device is clockwise; for another example, if the motor rotates reversely, the cutting direction and/or turning direction of the stirring device is counterclockwise. The fan is used to ventilate the storage cavity 101 and adjust a humidity in the storage cavity 101. The heating device is used to heat the storage cavity 101 so as to provide an appropriate temperature condition for the kitchen waste in the storage cavity 101. The heating device may include one or more devices selected from a heating tube, a heating sheet, and a heating wire.

The composter 10 also includes a weighing device which is not shown in FIG. 1. The weighing device is located below the storage cavity 101 and is used to determine a weight value of objects in the storage cavity 101. The weighing device may include any one of a weight sensor, a strain gauge load sensor, a piezoelectric sensor, a volumetric sensor, and a dynamic pressure sensor. The weighing device may also include other devices that can be used for weighing. The embodiment of the present application is not limiting a type of the weighing device. Since when the cavity cover 1011 covers the storage cavity 101, a pressure is formed on the weighing device. Therefore, a weight value obtained by the weighing device after weighing the storage cavity 10 includes the pressure generated by the cavity cover 1011 covering the storage cavity 101. Therefore, the weight value obtained is inaccurate. In one embodiment of the present application, the weighing device weighs the objects in the storage cavity 101 when the cavity cover 1011 is opened; it does not weigh the objects in the storage cavity 101 when the cavity cover 1011 is closed. In one embodiment of the present application, the weighing device counts a time duration begin from the cavity cover 1011 is opened, and when the time duration reaches a preset duration, the objects in the storage cavity 101 are weighed. The preset duration can be set according to an actual situation, such as 0.5 S, 1 S, etc. By waiting for the preset duration before measuring after the cavity cover 1011 is opened, the composter is prevented from shaking due to the opening of the cavity cover 1011, as the shaking of the composter may result the weight value is inaccurate, such that the accuracy of the weight value is improved. In one embodiment of the present application, the weighing device has a computing power and can calculate the weight value of the objects in the storage cavity 101 based on a measured data value. For example, the weighing device can subtract a weight value of the storage cavity 101 from the measured weight value to determine the weight value of the objects in the storage cavity 101. The weighing device can pre-record the weight of the storage cavity 101. In another embodiment of the present application, the weighing device does not have the computing power. After measuring the data value, the measured data value can be sent to a processor of the composter, so that the processor calculates an own weight value of the storage cavity 101 based on the data value. In one embodiment of the present application, the weighing device continues to measure the weight value of the storage cavity 101 when the cavity cover 1011 is opened. The processor of the composter counts the time duration when the processor detects that the cavity cover 1011 is open. When the time duration reaches the preset duration, the processor obtains the weight value of the storage cavity 101 currently collected by the weighing device. Based on the obtained weight value of the storage cavity 101 and the own weight value of the storage cavity 101, the weight value of the objects in the storage cavity 101 is obtained.

As shown in FIG. 1, the composter 10 also includes at least one ventilation hole 102. The ventilation hole 102 can ensure an air circulation inside the composter, and promote an aerobic state, and facilitate a growth and a metabolism of decomposed products, thereby accelerating the decomposition of kitchen waste. The ventilation hole 102 can provide an exchange channel between the external environment and an internal environment of the composter 10. For example, after the fan is turned on, gas in the internal environmental of the composter 10 can be discharged to the external environment through the ventilation hole 102, and gas of the external environmental can be sucked into the internal environment of the composter 10, thereby a purpose of changing the gas in the internal environment of the composter 10 is realized.

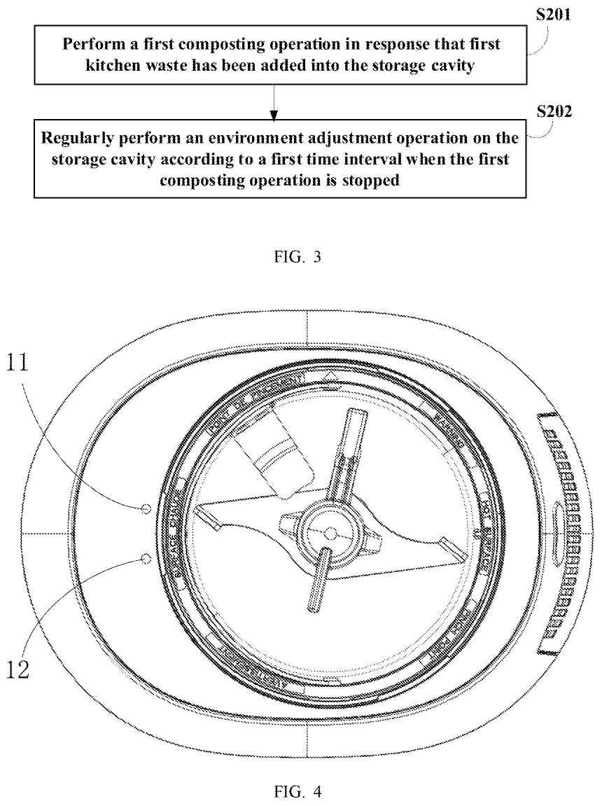

Those skilled in the art can understand that the schematic diagram is only an example of the composter and does not constitute a limitation on the composter. It may include more or fewer modules than shown in the figure, or combine certain modules, or different modules to realize the functions that the composter shown in FIG. 3.

FIG. 3 is a flow chart of a waste disposal method provided by one embodiment of the present application. This waste disposal method is applied to a composter. In one embodiment, the composter in the embodiment of the present application may be a small household composter, a household medium-sized composter, or other composter, for example, the composter shown in FIG. 1, and the composter may include a storage cavity. Depending on different needs, the order of blocks in this flowchart can be changed and some blocks can be omitted.

Block S201, the composter performs a first composting operation in response that the first kitchen waste has been added into the storage cavity.

The first kitchen waste is the kitchen waste added for the first time when there is no kitchen waste in the storage cavity.

In one embodiment of the present application, it can be determined based on the weighing device of the composter whether the user adds the first kitchen waste to the storage cavity. For example, when the weighing device of the composter detects that a difference between a current weight value of the storage cavity and the weight value of the storage cavity itself is greater than a preset weight difference, it is determined that the user adds the first kitchen waste to the storage cavity. The present application can determine whether the user adds the first kitchen waste to the storage cavity using another sensor, such as an infrared sensor.

In one embodiment of the present application, the composter further includes a cavity cover 1011 of the storage cavity. The composter performs the first composting operation in response that the first kitchen waste has been added into the storage cavity by: determining whether the cavity cover 1011 is closed when the first kitchen waste has been added into the storage cavity; and performing the first composting operation in response that the cavity cover 1011 is closed.

In one embodiment of the present application, the composter further includes a hall sensor corresponding to the cavity cover 1011. The hall sensor is provided on a casing shell of the composter, and the storage cavity is detachably received in the casing shell. The composter determines whether the cavity cover 1011 is closed by: determining whether the cavity cover 1011 is closed based on an output value of the hall sensor. In one embodiment of the present application, the cavity cover 1011 corresponds to one hall sensor. If the output value of the hall sensor is greater than a preset threshold value, the composter determines that the cavity cover 1011 is closed; if the output value of the hall sensor is less than or equal to the preset threshold value, the composter determines that the cavity cover 1011 is open. The output value may be a voltage value. The preset threshold value can be set according to an actual requirement, and is not limited in this embodiment. In one embodiment of the present application, the cavity cover 1011 corresponds to a plurality of hall sensors. If the output value of each of the plurality of hall sensors is greater than the preset threshold value, the composter determines that the cavity cover 1011 is closed; if the output value of each of the plurality of hall sensors is less than or equal to the preset threshold value, the composter determines that the cavity cover 1011 is open. For example, the cavity cover 1011 corresponds to two hall sensors, and the two hall sensors includes a first hall sensor and a second hall sensor. If the output values of the first hall sensor and the second hall sensor are both greater than the preset threshold value, the composter determines that the cavity cover 1011 is closed; if the output values of the first hall sensor and the second hall sensor are both less than or equal to the preset threshold value, the composter determines that the cavity cover 1011 is open. FIG. 4 is a schematic diagram of an application scenario of hall sensors provided by one embodiment of the present application. As shown in FIG. 4, the cavity cover 1011 of the composter is in a rotary type. The casing shell of the composter and the cavity cover 1011 can be rotated so that the cavity cover 1011 can be opened and closed by rotation. As shown in FIG. 4, a first hall sensor 11 and a second hall sensor 12 are provided above the casing shell of the composter. Magnetic pieces (not shown in FIG. 4) are provided on a lower side of the cavity cover 1011 (not shown in FIG. 4) at positions corresponding to the first hall sensor 11 and the second hall sensor 12. When the first hall sensor 11 senses the corresponding magnetic piece, the output value of the first hall sensor 11 is greater than the preset threshold value, similarly, when the second hall sensor 12 senses the corresponding magnetic piece, the output value of the second hall sensor 12 is greater than the preset threshold value; when the first hall sensor 11 does not sense the corresponding magnetic piece, the output value of the first hall sensor 11 is less than or equal to the preset threshold value, similarly, when the second hall sensor 12 does not sense the corresponding magnetic piece, the output value of the second hall sensor 12 is less than or equal to the preset threshold value. When the output values of the first hall sensor 11 and the second hall sensor 12 are both greater than the preset threshold value, the composter determines that the cavity cover 1011 is closed, which can avoid starting a composting mode when the cavity cover 1011 is not rotated in place; when the output values of the first hall sensor 11 and the second hall sensor 12 are all less than or equal to the preset threshold value, the composter determines that the cavity cover 1011 is open. According to the above implementation method, a status of the cavity cover 1011 can be accurately determined through the output values of the hall sensors.

In one embodiment of the present application, the composter includes a motor, a fan and a heating device. The composter performs the first composting operation by: operating according to a first mode until a temperature of the storage cavity is greater than a first temperature threshold; and operating according to a second mode until a humidity in the storage cavity is less than or equal to a first humidity threshold, after the temperature of the storage cavity is greater than the first temperature threshold. The first mode includes one or more of controlling the motor to rotate according to a first motor mode, controlling the fan to rotate, and controlling the heating device to heat. The second mode includes controlling the motor to rotate according to a second motor mode and/or controlling the heating device to heat according to a preset heating mode.

The first temperature threshold can be set according to the user's needs, for example, set to 63°. In one embodiment of the present application, the first temperature threshold can be determined based on a target decomposition product corresponding to the first kitchen waste, so that the determined first temperature threshold does not exceed a highest temperature at which the target decomposition product can survive. The first motor mode can be set according to the user's needs, for example, the second motor mode includes controlling the motor to rotate in a forward direction for 20 seconds, stop for 40 seconds, and rotate in a reverse direction for 20 seconds. The first humidity threshold can be set according to the user's needs, for example, set to 45%. In one embodiment of the present application, the first humidity threshold can be determined based on a type of kitchen waste. Different types of kitchen waste can correspond to different first humidity thresholds, so that the determined first humidity threshold can increase a composting rate of kitchen waste. The composter may determine the first humidity threshold in response to a user input of the type of the first kitchen waste.

The second motor mode can be set according to the user's needs. The second motor mode can be different from the first motor mode, or it can be the same as the first motor mode. For example, the second motor mode includes controlling the motor to rotate in the forward direction for 20 seconds, stop for 40 seconds, and rotate in the reverse direction for 20 seconds.

The heating mode is used to control the temperature of the storage cavity to be within a target temperature range. For example, when the target temperature range is (57°, 63°), the heating mode includes starting the heating device to heat until the temperature of the storage cavity reaches 63 degrees when the temperature of the storage cavity drops to 57 degrees; stop heating by the heating device when the temperature of the storage cavity reaches 63 degrees; perform the aforementioned steps in a loop to keep the temperature of the storage cavity within the temperature target range (57°, 63°). A third motor mode can be set according to the user's needs. For example, the third motor mode includes controlling the motor to rotate in the forward direction for 20 seconds, stop for 90 seconds, and rotate in the reverse direction for 30 seconds.

The target temperature range is a temperature range suitable for the survival of target microorganisms that decompose the first kitchen waste. In one embodiment of the present application, the composter determines a biological species of the target microorganisms that decompose the first kitchen waste; and determines the target temperature range based on a temperature range (hereinafter referred to as “active temperature range”) of the biological species that are active. In one embodiment of the present application, the active temperature range of the target microorganisms can be determined as the target temperature range. For example, the active temperature range of the target microorganisms is (57°, 63°), and (57°, 63°) can be determined as the target temperature range. In another embodiment of the present application, a temperature range included in the active temperature range of the target microorganisms can be determined as the target temperature range. For example, the active temperature range of the target microorganisms is (50°, 70°), then (57°, 63°) can be determined as the target temperature range. In one embodiment of the present application, the composter can preset different temperature ranges corresponding to different biological species in advance, so that the target temperature range can be quickly determined based on the biological species of the target microorganisms. In the above embodiment, by determining the active temperature range of the target microorganisms as the target temperature range, the determined target temperature range can be made more suitable for the growth and metabolism of the target microorganisms, thereby accelerating the decomposition of kitchen waste and improving an efficiency of decomposing kitchen waste.

In one embodiment of the present application, the biological species of the target microorganisms that decompose the first kitchen waste can be determined based on microorganisms information input by the user. In one embodiment of the present application, the microorganisms information includes a name of the target microorganisms. The composter may include a display screen, the display can be a touch play, and the user may input the microorganisms information using the display screen before or after adding the first kitchen waste. For example, the microorganisms information can be input by operating an option displayed on the display screen. For another example, the user can input the microorganisms information through a virtual keyboard displayed on the display screen. In another embodiment of the present application, the composter can establish a communication connection with other electronic devices, such as a mobile phone of the user. The user can input the microorganisms information on the mobile phone, and the mobile phone can send the microorganisms information to the composter. A heating power of the heating device can be set according to user needs. During a process of composting (hereinafter referred to as “composing process”) kitchen waste, the heating power of the heating device can be consistent or inconsistent for each time of heating, and there is no limit here.

In one embodiment of the present application, when the humidity in the storage cavity is less than the first humidity threshold, the composter stops the composting operation. In one embodiment of the present application, the composter calculates a time duration of waiting (hereinafter referred to as “waiting duration”) in response that the humidity in the storage cavity is less than the first humidity threshold; and stops the composting operation in response that the waiting duration is greater than a preset duration threshold and no operation instruction is received, the operation instruction may be received from the mobile phone of the user or may be generated in response to an user operation on the composter.

Since the kitchen waste includes a lot of water, in an initial stage of the composting process, the water in the kitchen waste precipitates and the humidity in the storage cavity increases. In a middle stage or a later stage of the composting process, the humidity in the storage cavity decreases as the decomposing of the kitchen waste. Therefore, during the entire composting process, a change trend of the humidity in the storage cavity shows a trend of an inverted V. Two temperature values that are the same as the first temperature threshold are occurred during the composting process, and one of the two temperature values is occurred in the initial stage of the composting process, and another one of the two temperature values is occurred in the later stage of the composting process. The embodiment of the present application requires the use of the third mode for operation in the later stage of the composting process. In one embodiment of the present application, in order to avoid operating in the third mode in the initial stage of the composting process, if the temperature of the storage cavity is greater than the first temperature threshold, the composter operates according to the second mode, until a time duration (hereinafter referred to as “composting duration”) of composting the first kitchen waste is greater than a first preset duration and the humidity in the storage cavity is less than or equal to the first humidity threshold. Specifically, the composter calculates the composting duration when the composter operates according to the first mode. During the operation in the second mode, if the composting duration is greater than the first preset duration, the composter determines that the humidity in the storage cavity is less than or equal to the first humidity threshold; if the composter determines that the humidity in the storage cavity is less than or equal to equal to the first humidity threshold, the composter stops operating according to the second mode.

In one embodiment of the present application, if the humidity in the storage cavity is less than or equal to the first humidity threshold, the composter operates according to the third mode until the temperature of the storage cavity is less than a second temperature threshold. The third mode includes controlling the motor to rotate according to the third motor mode and/or controlling the fan to rotate. The second temperature threshold is a temperature value with a lower risk coefficient, such as a temperature value that not cause burns to a user or a temperature that not cause burns to plants. The second temperature threshold can be set according to the user's needs, such as 35° or 40°. According to the above embodiment, the processed kitchen waste can be cooled down at an end of the composting process to avoid the processed kitchen waste scalding users or plants, thereby improving a safety of the composting process. In one embodiment of the present application, when the temperature of the storage cavity is less than the first temperature threshold, the composter stops the composting operation. In one embodiment of the present application, when the temperature of the storage cavity is less than the first temperature threshold, the composter calculates the waiting duration; if the waiting duration is greater than the preset duration threshold and no operation instruction is received, the composter stops the composting operation, the operation instruction may be received from the mobile phone of the user or may be generated in response to an user operation on the composter.

Block S202, when the first composting operation is stopped, the composter regularly performs an environment adjustment operation on the storage cavity according to a first time interval.

The environment adjustment operation is used to adjust the environment of the storage cavity so that the adjusted environment meets the composting condition of the first kitchen waste. The composting condition can be set according to actual needs. In one embodiment of the present application, the composting condition may include one or more of a temperature condition, a humidity condition, and an air oxygen content. The above conditions are only examples, and other composting condition may also be included in actual applications.

In one embodiment of the present application, before regularly performing the environment adjustment operation on the first kitchen waste according to the first time interval, the composter further performs the following operations: obtaining a first humidity in the storage cavity after the first composting operation is stopped; determining the first time interval according to the first humidity. The first humidity is a humidity value detected by a humidity sensor of the composter when the composting operation is stopped. In one embodiment of the present application, the composter presets different first time intervals corresponding to different first humidities. For example, the greater the humidity value of the first humidity is, the less the corresponding first time interval is. For example, when the first humidity is 50%, the corresponding first time interval is 1.5 hours; when the first humidity is 45%, the corresponding first time interval is 2 hours.

In one embodiment of the present application, before regularly performing the environmental adjustment operation on the first kitchen waste according to the first time interval, the composter further performs the following operations: after detecting that the composting operation has been stopped, determining a current storage weight value of the storage cavity in response that the cavity cover 1011 of the storage cavity is opened; determining the first time interval based on the current storage weight value. In one embodiment of the present application, the composter presets different first time intervals corresponding to different current storage weights. In one embodiment, the greater the current storage weight is, the less the corresponding first time interval is. For example, if the current storage weight is 3 kg, the corresponding first time interval is 1.5 hours; if the current storage weight is 2.5 kg, the corresponding first time interval is 2 hours.

In one embodiment of the present application, the composter further performs the following operations: after detecting that the cavity cover 1011 of the storage cavity is opened, determining the current storage weight of the storage cavity; if a difference between the current storage weight and a target storage weight of the storage cavity is less than a preset difference threshold, generating a prompt to prompt the user to take out the kitchen waste in the storage cavity. The preset difference threshold can be set according to the actual situation, such as 0.1 kg, 0.2 kg, etc.

In one embodiment of the present application, the environment adjustment operation includes one or more of controlling the motor to rotate according to a target motor mode for a preset time, controlling the fan to rotate for a preset duration, and controlling the heating device to heat to a target temperature. The target motor mode can be set according to the user's needs, such as setting the motor to first rotate in the forward direction for 30 s and then rotate in the reverse direction for 30 s. The preset duration can be set according to user needs, such as 1 minute, 2 minutes, 5 minutes, etc. The target temperature is a temperature suitable for the survival of the target microorganisms that decompose the first kitchen waste. The target temperature can be set according to the user's needs, such as 63°.

In the above embodiment, the first composting operation can be performed on the first kitchen waste added into the storage cavity, so as to complete the first composting of the first kitchen waste; when it is detected that the first composting operation is stopped, the composting of the first kitchen waste is determined to be completed. The environment adjustment operation is regularly performed on the storage cavity according to the first time interval to adjust the environment of the storage cavity so that the adjusted environment meets the composting condition of the first kitchen waste, so that the first kitchen waste can continue to be composted, which avoids the situation that the first kitchen waste become rotten because the first kitchen waste is not taken out in time after the first composting is completed, which improves the convenience of processing kitchen waste and also improves the convenience of using the composter.

After adding the first kitchen waste into the storage cavity, the user can continue to put new kitchen waste, that is, second kitchen waste, into the storage cavity without taking out the first kitchen waste. The second kitchen waste is kitchen waste newly added into the storage cavity after the first composting operation has been performed on the first kitchen waste and before the first kitchen waste is taken out from the storage cavity. Therefore, in one embodiment of the present application, the composter further performs the following operations: after detecting that the second kitchen waste has been added into the storage cavity, in response that the cavity cover 1011 of the storage cavity is closed, executing a second composting operation; in response that the second composting operation is stopped, regularly performing the environment adjustment operation on the storage cavity according to a second time interval. The environment adjustment operation is used to adjust the environment of the storage cavity, so that the environment meets a composting condition of the second kitchen waste after the adjustment. The method of determining the second time interval is similar to the method of determining the first time interval. Some specific implementations of determining the second time interval may be as described above for the first time interval.

In one embodiment of the present application, performing the second composting operation includes: operating according to the first mode until the temperature of the storage cavity is greater than the first temperature threshold, and calculating a reaction duration; if the temperature of the storage cavity is greater than the first temperature threshold, operating according to the second mode until the reaction duration is greater than a second preset duration and the humidity in the storage cavity is less than or equal to the first humidity threshold; if the humidity in the storage cavity is less than or equal to the first humidity threshold, operating according to the third mode until the temperature of the storage cavity is lower than the first temperature threshold.

The second preset duration can be set according to the user's needs. In one embodiment of the present application, the second preset duration may be determined based on one or more of the second kitchen waste and the current humidity in the storage cavity. In one embodiment of the present application, a weight of the second kitchen waste can be determined based on a difference between a first weight of the storage cavity at a first moment after the cavity cover 1011 is opened and a second weight of the storage cavity at a second moment before the cavity cover 1011 is closed. The first moment and the second moment can be set according to the user's needs. For example, the first moment can be set as a time of 1 s after the cavity cover 1011 is opened, and the second moment can be set as a time of 1 s before the cavity cover 1011 is closed. For example, the cavity cover 1011 is opened at 17:10 pm, and after 20 seconds, the cavity cover 1011 is closed, i.e., the cavity cover 1011 is closed at 17:30 pm. Then, the difference between the first weight of the storage cavity at 17:11 pm after the cavity cover 1011 is opened and the second weight of the storage cavity at 17:29 pm can be determined as the weight of the second kitchen waste. Regarding some specific implementations of determining the second preset duration, the relevant description of the first preset duration mentioned above may be familiar.

Some specific implementations in performing the second composting operation may be based on the above related descriptions of the first composting operation.

According to the above embodiment, the user can continue to compost the second kitchen waste added by the user without taking out the first kitchen waste, which improves the convenience of use of the composter. At the same time, when the composting operation of the second kitchen waste is stopped, the environment adjustment operation is regularly performed on the storage cavity according to the second time interval, and the environment of the storage cavity is adjusted so that the adjusted environment is consistent with the composting condition of kitchen waste. So that the kitchen waste can continue to be composted, avoiding the situation where kitchen waste is not taken out in time after composting, causing kitchen waste to become rotten, which improves the convenience of processing kitchen waste and the convenience of use of the composter. At the same time, the composter sets the second time interval smaller than the first time interval, so that when the kitchen waste in the storage cavity is increased, the adjustment of the environment in the storage cavity becomes timely and the environment in the storage cavity can be better maintained, further avoiding the occurrence of rotten of kitchen waste.

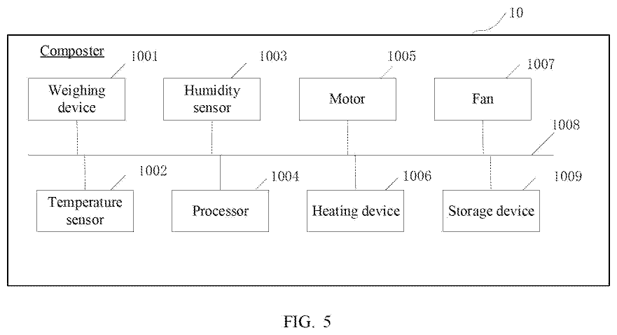

The present application also provides a composter. FIG. 5 is a schematic structural diagram of the composter provided by the embodiment of the present application. As shown in FIG. 5, in one embodiment of the present application, a composter 10 can be a small household composter, a medium-sized household composter, or other composter. The embodiment of the present application does not place any restrictions on the specific type of the composter 10.

As shown in FIG. 5, the composter 10 may include, but is not limited to, a weighing device 1001, a temperature sensor 1002, a humidity sensor 1003, a processor 1004, a motor 1005, a heating device 1006, a fan 1007, a bus 1008, and a storage device 1009.

Those skilled in the art can understand that the schematic diagram is only an example of the composter 10 and does not constitute a limitation of the composter 10. It may include more or fewer components than shown in the illustrations, or combine certain components, or different components. For example, the composter 10 may also include a network access device and the like.

The weighing device 1001 can be used to determine the weight value of the object in the storage cavity. In one embodiment of the present application, the weighing device 1001 weighs the object in the storage cavity when the cavity cover 1011 of the storage cavity is opened. The weighing device 1001 can subtract the weight value of the storage cavity from the measured weight value to determine the weight value of the objects in the storage cavity. The weighing device 1001 can pre-record the weight value of the storage cavity.

The temperature sensor 1002 may be used to measure the temperature of the internal environment of the storage cavity.

The humidity sensor 1003 can be used to measure the humidity of the internal environment of the storage cavity.

The processor 1004 is a computing core and a control center of the composter 10. It uses various interfaces and lines to connect various parts of the entire composter 10, and executes an operating system of the composter 10 as well as various installed applications, program codes, etc. The processor 1004 is used to implement the waste deposal method in the above embodiment. For example, the processor 1004 can issue corresponding instructions to the devices in the composter 10 through the bus 1008, so that the above waste disposal method can be implemented.

The motor 1005 is used to drive the stirring device in the storage cavity to achieve cutting and/or flipping of objects in the storage cavity. The motor 1005 can rotate clockwise and counterclockwise.

The heating device 1006 is used to heat the storage cavity to increase the temperature of the kitchen waste in the storage cavity to provide an environment more suitable for the decomposition of the kitchen waste.

The fan 1007 is used to ventilate the storage cavity. In one embodiment of the present application, the fan can be used to adjust the humidity in the storage cavity.

The bus 1008 is at least used to provide a communication channel between the weighing device 1001, the temperature sensor 1002, the humidity sensor 1003, the processor 1004, the motor 1005, the heating device 1006, the fan 1007, and the storage device 1009 of the composter 10. For example, the processor 1004 can send an instruction of a first motor mode to the motor 1005 through the bus 1008, so that the motor 1005 rotates according to the first motor mode. For another example, the processor 1004 can send an instruction of a heating mode to the heating device 1006 through the bus 1008, so that the heating device 1006 heats according to the heating mode.

In one embodiment, the storage device 1009 may include a volatile memory, and may also include a non-volatile memory, such as a hard disk, internal memory, plug-in hard disk, smart memory card (SMC), secure digital (SD) card, a flash memory card (Flash Card), at least one magnetic disk storage device, flash memory device, or other storage devices.

The storage device 1009 can be used to store an operating system and one or more computer programs. For example, the storage device 1009 stores the computer program which when executed by the processor 1004, the above-mentioned waste deposal method can be realized.

In the several embodiments provided in the present application, it should be understood that the disclosed systems, devices and methods can be implemented in other ways. For example, the device embodiment described above are only illustrative. For example, the division of modules is only a logical function division, and there may be other division methods in actual implementation. Those skilled in the art can understand that the schematic diagram in FIG. 4 is only an example of the composter and does not constitute a limitation on the composter. The composter may include more or fewer modules than shown in the FIG. 4 to realize the waste deposal method shown in FIG. 3, or combining certain modules, or different modules.

Modules described as separate components may or may not be physically separated, and components shown as modules may or may not be physical units, that is, they may be located in one place, or they may be distributed to multiple network units. Some or all of the modules can be selected according to actual needs to achieve the purpose of the solution of this embodiment.

In addition, each functional module in various embodiments of the present application can be integrated into one processing unit, or each unit can exist physically alone, or two or more units can be integrated into one unit. The above-mentioned integrated unit can be implemented in the form of hardware or in the form of hardware plus software function modules.

Therefore, the embodiments should be regarded as illustrative and non-restrictive from any point of view, and the scope of the application is defined by the appended claims rather than the above description, and it is therefore intended that all claims falling within all changes within the meaning and the scope of the equivalent elements are included in the present application. Any accompanying reference signs in the claims shall not be construed as limiting the claim.

Finally, it should be noted that the above embodiments are only used to illustrate the technical solutions of the present application and are not limiting. Although the present application has been described in detail with reference to the preferred embodiments, those of ordinary skill in the art should understand that the technical solutions of the present application can be modified. Modifications or equivalent substitutions may be made without departing from the spirit and scope of the technical solution of the present application.

What is claimed is:

1. A waste disposal method applicable to a composter, wherein the composter comprises a storage cavity, and the waste disposal method comprises:
performing a first composting operation in response that first kitchen waste has been added into the storage cavity;
in response that the first composting operation is stopped, adjusting an internal environment of the storage cavity to meet a composting condition of the first kitchen waste by performing an environment adjustment operation on the storage cavity according to a first time interval.

2. The waste disposal method according to claim 1, wherein the composter further comprises at least one hall sensor and a cavity cover, and performing the first composting operation in response that first kitchen waste has been added into the storage cavity comprises:
determining whether the cavity cover is closed based on an output value of the at least one hall sensor, when the first kitchen waste has been added into the storage cavity;
performing the first composting operation in response that the cavity cover is closed.

3. The waste disposal method according to claim 1, wherein the composter further comprises a motor, a fan and a heating device, and the environmental adjustment operation comprises at least one of controlling the motor to rotate for a preset duration according to a target motor mode, controlling the fan rotate for the preset duration, and controlling the heating device to heat the storage cavity to make an internal temperature of the storage cavity to a target temperature.

4. The waste disposal method according to claim 1, wherein performing the first composting operation comprises:
operating according to a first mode until a temperature of the storage cavity is greater than a first temperature threshold; and
operating according to a second mode until a humidity in the storage cavity is less than or equal to a first humidity threshold, in response that the temperature of the storage cavity is greater than the first temperature threshold;
wherein the first mode comprises at least one of controlling the motor to rotate according to a first motor mode, controlling the fan to rotate, and controlling the heating device to heat; and the second mode comprises controlling the motor to rotate according to a second motor mode and/or controlling the heating device to heat according to a preset heating mode, the preset heating mode controls the temperature of the storage cavity to be within a target temperature range.

5. The waste disposal method according to claim 4, wherein operating according to the second mode until the humidity in the storage cavity is less than or equal to the first humidity threshold, in response that the temperature of the storage cavity is greater than the first temperature threshold comprises:
in response that the temperature of the storage cavity is greater than the first temperature threshold, operating according to the second mode until a composting duration of the first kitchen waste is greater than a first preset duration and the humidity in the storage cavity is less than or equal to the first humidity threshold.

6. The waste disposal method according to claim 4, wherein performing the first composting operation further comprises:
in response that the humidity in the storage cavity is less than or equal to the first humidity threshold, operating according to a third mode until the temperature of the storage cavity is less than a second temperature threshold, the third mode comprising controlling the motor to rotate according to the third motor mode and/or controlling the fan to rotate.

7. The waste disposal method according to claim 4, further comprising:
determining a biological species of target microorganisms that decompose the first kitchen waste; and
determining a target temperature range based on an active temperature range of the biological species.

8. The waste disposal method according to claim 1, wherein before performing the environment adjustment operation on the storage cavity according to the first time interval, the method further comprises:
detecting a first humidity in the storage cavity after the first composting operation is stopped;
determining the first time interval based on the first humidity.

9. The waste disposal method according to claim 8, further comprising:
in response that the second kitchen waste has been added into the storage cavity, executing a second composting operation in response that the cavity cover of the storage cavity is closed;
in response that the second composting operation is stopped, adjusting the environment of the storage cavity to meet a composting condition of the second kitchen waste by performing the environment adjustment operation on the storage cavity according to a second time interval.

10. The waste disposal method according to claim 9, wherein performing the second composting operation comprises:
operating according to the first mode until the temperature of the storage cavity is greater than the first temperature threshold, and calculating a reaction duration;
in response that the temperature of the storage cavity is greater than the first temperature threshold, operating according to the second mode until the reaction duration is greater than a second preset duration and the humidity in the storage cavity is less than or equal to the first humidity threshold;
in response that the humidity in the storage cavity is less than or equal to the first humidity threshold, operating according to the third mode until the temperature of the storage cavity is lower than the first temperature threshold.

11. A composter comprising:
a storage cavity;
a storage device;
at least one processor; and
the storage device storing a computer program, which when executed by the at least one processor, cause the at least one processor to:
perform a first composting operation in response that first kitchen waste has been added into the storage cavity;
in response that the first composting operation is stopped, adjust an internal environment of the storage cavity to meet a composting condition of the first kitchen waste by performing an environment adjustment operation on the storage cavity according to a first time interval.

12. The composter according to claim 11, further comprising at least one hall sensor and a cavity cover, wherein the at least one processor performs the first composting operation in response that first kitchen waste has been added into the storage cavity by:
determining whether the cavity cover is closed based on an output value of the at least one hall sensor, when the first kitchen waste has been added into the storage cavity;
performing the first composting operation in response that the cavity cover is closed.

13. The composter according to claim 11, further comprising a motor, a fan and a heating device, wherein the environmental adjustment operation comprises at least one of controlling the motor to rotate for a preset duration according to a target motor mode, controlling the fan rotate for the preset duration, and controlling the heating device to heat the storage cavity to make an internal temperature of the storage cavity to a target temperature.

14. The composter according to claim 11, wherein the at least one processor performs the first composting operation by:
operating according to a first mode until a temperature of the storage cavity is greater than a first temperature threshold; and
operating according to a second mode until a humidity in the storage cavity is less than or equal to a first humidity threshold, in response that the temperature of the storage cavity is greater than the first temperature threshold;
wherein the first mode comprises at least one of controlling the motor to rotate according to a first motor mode, controlling the fan to rotate, and controlling the heating device to heat; and the second mode comprises controlling the motor to rotate according to a second motor mode and/or controlling the heating device to heat according to a preset heating mode, the preset heating mode controls the temperature of the storage cavity to be within a target temperature range.

15. The composter according to claim 14, wherein the at least one processor operates according to the second mode until the humidity in the storage cavity is less than or equal to the first humidity threshold, in response that the temperature of the storage cavity is greater than the first temperature threshold by:
in response that the temperature of the storage cavity is greater than the first temperature threshold, operating according to the second mode until a composting duration of the first kitchen waste is greater than a first preset duration and the humidity in the storage cavity is less than or equal to the first humidity threshold.

16. The composter according to claim 14, wherein the at least one processor performs the first composting operation by:
in response that the humidity in the storage cavity is less than or equal to the first humidity threshold, operating according to a third mode until the temperature of the storage cavity is less than a second temperature threshold, the third mode comprising controlling the motor to rotate according to the third motor mode and/or controlling the fan to rotate.

17. The composter according to claim 14, wherein the at least one processor is further caused to:
determine a biological species of target microorganisms that decompose the first kitchen waste; and
determine a target temperature range based on an active temperature range of the biological species.

18. The composter according to claim 11, wherein before the at least one processor performs the environment adjustment operation on the storage cavity according to the first time interval, the at least one processor is further caused to:
detect a first humidity in the storage cavity after the first composting operation is stopped;
determine the first time interval based on the first humidity.

19. The composter according to claim 18, wherein the at least one processor is further caused to:
in response that the second kitchen waste has been added into the storage cavity, execute a second composting operation in response that the cavity cover of the storage cavity is closed;
in response that the second composting operation is stopped, adjust the environment of the storage cavity to meet a composting condition of the second kitchen waste by performing the environment adjustment operation on the storage cavity according to a second time interval.

20. The composter according to claim 19, wherein the at least one processor performs the second composting operation by:
operating according to the first mode until the temperature of the storage cavity is greater than the first temperature threshold, and calculating a reaction duration;
in response that the temperature of the storage cavity is greater than the first temperature threshold, operating according to the second mode until the reaction duration is greater than a second preset duration and the humidity in the storage cavity is less than or equal to the first humidity threshold;
in response that the humidity in the storage cavity is less than or equal to the first humidity threshold, operating according to the third mode until the temperature of the storage cavity is lower than the first temperature threshold.
